(19) United States
(12) Patent Application Publication
(10) Pub. No.: US 2025/0381795 A1
(43) Pub. Date: Dec. 18, 2025

(54) WHEEL RIM HAVING ANTI-SLIP TAPE

(71) Applicant: Lacks Enterprises, Inc., Grand Rapids, MI (US)

(72) Inventors: Colin Snyder, Caledonia, MI (US); Michael Nuiver, Hamilton, MI (US); Dan McGillicuddy, Lowell, MI (US); Dylan Bussa, Byron Center, MI (US); Chris McCloskey, Grand Rapids, MI (US)

(21) Appl. No.: 19/234,605

(22) Filed: Jun. 11, 2025

Related U.S. Application Data
(60) Provisional application No. 63/658,971, filed on Jun. 12, 2024.

(51) Int. Cl. B60B 21/12

(52) U.S. Cl. CPC B60B 21/12; B60B 2310/318; B60B 2900/523

(57) ABSTRACT

A system for reducing slippage between a tire and wheel rim includes providing anti-slip tape on the wheel rim at a wheel-tire interface of the wheel rim. When the tire is mounted on the wheel rim, the anti-slip tape is disposed between the tire and the wheel rim, providing a high friction abrasive surface in direct contact with the tire. The tape may be applied to the bead flanges of the wheel rim, which extend radially outward from the body portion of the wheel rim. The bead seats, which are adjacent the bead flanges, providing sealing between the tire and the wheel rim. The tape applied to the wheel rim extends around the circumference of the wheel rim, and may project outwardly from the surface of the wheel-tire interface, or may be disposed in a recess to be flush with the surface.

### FIELD

The present disclosure is directed to vehicle wheels. More particularly, the present disclosure is directed to anti-slip structure for vehicle wheel rims that limits slipping between the wheel rim and a tire mounted thereon.

### BACKGROUND

Wheel rims have been provided that include anti-slip features for preventing slippage between the wheel rim and the tire mounted to the wheel rim, in particular during high-torque operations such as racing. Wheel slippage is also a concern for off-road operation, where tire pressures can be relatively low. Slippage may occur on carbon fiber wheel rims as well as alloy wheels or other forms of wheels for supporting a pressurized tire.

Vehicle wheels typically include a radially outer rim portion and a central hub portion, with the central hub portion being integrally formed with the rim portion or separately attached to the rim portion. The rim portion includes an axially inner end and an axially outer end, each including a flange that extends radially outward for mounting the tire axially therebetween.

Axially inward from the flanges at each end is a tire bead seat, where the tire bead contacts the wheel rim and is sealed to the wheel rim. The flange provides axial support the tire sidewall.

To prevent slippage, some wheel rims include a texture in the form of ribs, fins, grooves, etc., which increases the friction between the engaged surface of the tire and the wheel rim. However, the inclusion of these ribs or other textured surfaces formed in the wheel can result in problems with creating the appropriate seal between the tire and the wheel rim surface. Thus, there is a compromise in the construction of wheel rims between providing a proper seal and preventing or reducing slippage.

In one approach, alloy wheels are knurled in the region of the bead seat to produce a texture in the form of grooves formed in the surface (as a negative feature in the surface), because a positive feature would inhibit tire sealing. However, the knurling can also affect tire sealing, and the negative feature is less effective to preventing slippage relative to positive features.

In one approach, a high friction coating having projecting features is applied to the bead seat region, but this high friction coating can also affect sealing.

In another approach, used in some composite wheels, a high friction coating is applied to the tire bead flanges, rather than the bead seat, in order to keep the bead seat sealing region arranged for sealing. The high friction coating may include a raised feature that helps prevent slippage. However, the process of creating the raised feature is labor intensive, including masking of the bead seat, applying a paint, applying grit into the wet paint, and then spraying more paint to lock in the grit particles. This process can be messy, time-consuming, and is subject to variance in the actual texture and roughness achieved.

Accordingly, improvements can be made to the anti-slip features of wheel rims.

### SUMMARY

It is an object of the present disclosure to provide an improved anti-slip feature for a wheel rim, which reduces slippage while maintaining a sufficient seal between the corresponding surfaces of the wheel rim and the tire.

According to an aspect, a vehicle wheel structure includes: a wheel rim having a rotational axis, a front end and a rear end at opposite axial ends of the wheel rim, and a body portion extending between the front end and the read end; a front flange disposed at the front end and a rear flange disposed at the rear end, wherein the front and rear flanges project radially outward from the body portion; a front bead seat of the front end disposed axially inward relative to the front flange; a rear bead seat of the rear end disposed axially inward relative to the rear flange; a wheel-tire interface portion disposed at both the front end and the rear end of the wheel rim; and an anti-slip tape applied to the wheel-tire interface portion, wherein the anti-slip tape includes a high-friction surface facing outwardly from the wheel rim such that a tire mounted to the wheel rim is in direct contact with the high-friction surface.

In one aspect, the tape includes an adhesive disposed between the tape and the wheel-tire interface portion of the wheel. In one aspect, the adhesive is provided on a backing of the tape. In one aspect the adhesive is provided on the wheel rim at the wheel-tire interface portion.

In one aspect, the tape includes a plurality of abrasive particles configured to engage a contact surface of the tire. In one aspect, the particles have a mono-modal size distribution or a multi-modal size distribution.

In one aspect, the tape extends in a substantially continuous loop circumferentially around the wheel rim. In one aspect, the tape has opposite ends that form a butt-joint. In one aspect, the tape extends around the wheel rim multiple times and defines multiple layers.

In one aspect the tape is compliant and conforms to a surface curvature of the wheel-tire interface portion.

In one aspect, the tape projects from an outer surface of the wheel-tire interface portion and is proud relative to the outer surface. In one aspect, the tape is provided within a recess or cavity formed in the wheel-tire interface portion and is flush with the outer surface of the wheel-tire interface portion.

In one aspect, the tape includes multiple separate sections disposed around the circumference of the wheel rim along the wheel-tire interface portion, such that circumferentially adjacent sections are spaced apart from each other. In one aspect, the tape includes a plurality of separate strips that are disposed adjacent each other at separate axial and radial locations along the wheel-tire interface portion.

In one aspect, the wheel rim is a composite rim or an alloy rim.

In one aspect, a tire is mounted to the wheel rim and sealed with the front bead seat and the rear bead seat, the tape is in direct contact with the tire and the wheel rim at the wheel-tire interface portion, the abrasive surface of the tape is in direct contact with the tire, and an adhesive is disposed between the tape and the wheel rim.

In one aspect, the tape is disposed between the tire and the front flange and between the tire and the rear flange.

Additional aspects and features are described in the detailed description below and illustrated in the drawings.

### BRIEF DESCRIPTION OF THE DRAWINGS

The present disclosure will be described in further detail below and with reference to the appended drawings, in which:

FIG. 1 is a rear view of a wheel rim showing anti-slip tape applied to an inner surface of a front bead flange;

FIG. 2 is front perspective of the wheel showing anti-slip tape applied to an inner surface of a rear bead flange;

FIG. 3 is a partial cross-sectional view of the wheel rim, illustrating the tape applied to the bead flanges, with the tape projecting from the surface of the bead flanges;

FIG. 4 is a partial cross-section view of the wheel rim, illustrating the tap applied within a recess formed in the bead flanges, with the tape being flush with the surface of the bead flanges;

FIG. 5 is a partial cross-section view of the front bead flange, illustrating multiple rings of tape adjacent to each other and disposed along the surface of the bead flange;

FIG. 6 is a partial cross-section view illustrating multiple layers of tape in an exploded view, as well as tape applied to a further wheel-tire interface; and

FIG. 7 is a schematic view illustrating multiple circumferential sections of tape that combine with each other to form a circumferential ring.

### DETAILED DESCRIPTION

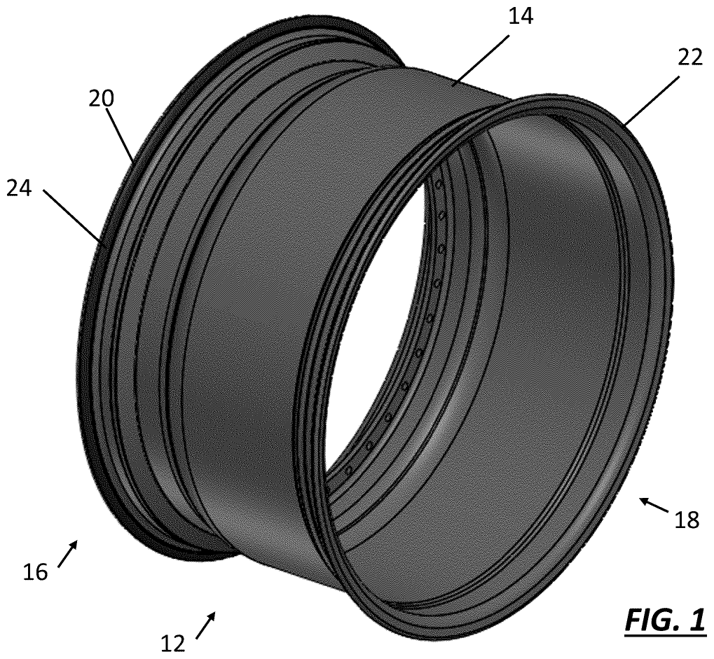

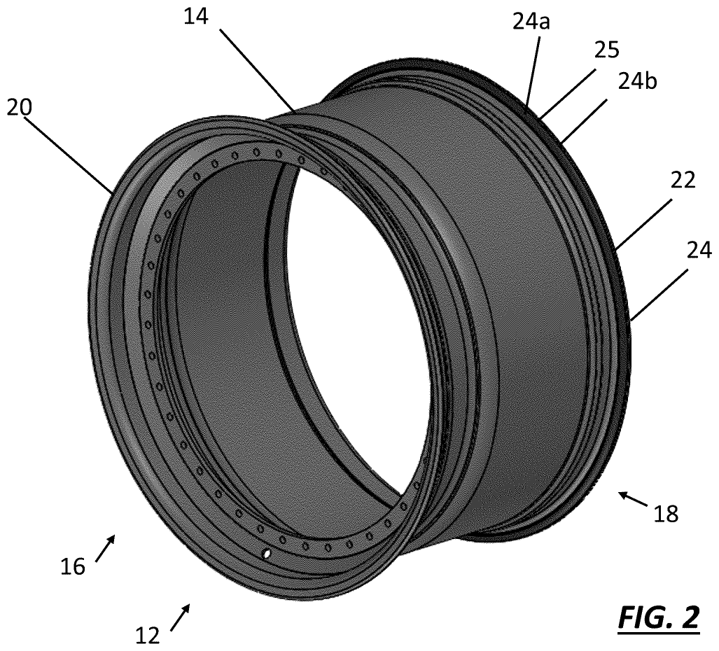

With reference initially to FIGS. 1 and 2, a vehicle wheel is shown in the form of a wheel rim 12, illustrated in both a rear isometric view and a front isometric view. The wheel rim 12 is illustrated without a wheel center portion. It will be appreciated that the wheel center portion may be attached to the wheel rim 12 in a known manner, or the wheel center portion may be integrally formed with the wheel rim 12.

The wheel rim 12 includes a tubular body portion 14 extending axially between a front end 16 and a rear end 18 of the wheel rim 12. The front end 16 includes a front bead flange 20, and the rear end 18 includes a rear bead flange 22. The bead flanges 20, 22 project radially outward from the body portion 14 at the front end 16 and rear end 18, respectively.

FIG. 1 illustrates the inner surface of the front bead flange 20. FIG. 2 illustrates the inner surface of the rear bead flange 22. In both FIG. 1 and FIG. 2, an anti-slip tape member 24 is applied to the respective inner surfaces of the front bead flange 20 and the rear bead flange 22. The tape member 24, in this embodiment, extends substantially fully circumferentially around the bead flanges 20, 22. The tape member 24 includes a high friction outer surface configured to directly contact and bear against the tire when the tire is mounted to the wheel rim 12.

As shown, the tape member 24 is a continuous loop around the wheel rim 24. To provide a relatively flat surface against which the tire surface will rest, the tape member 24 may include opposite ends 24a and 24b that are joined together as a butt-joint 25, as illustrated in FIG. 2. It will be appreciated that such an arrangement may also be used for the tap member 24 of FIG. 1. The ends 24a and 24b may be defined during the application of the tape 24 to the wheel rim 12 and cut to size to provide the butt-joint 25. It will be appreciated that a small gap may be present between the ends of the tape at the butt joint 25.

In another approach, the tape 24 may be wrapped around the circumference of the wheel rim multiple times, such that the tape 24 will overlap itself. In this approach, the ends 24a and 24b may be circumferentially aligned, but offset relative to each other due to the multiple layers. Put another way, the ends 24a and 24b terminate at approximately the same location, thereby creating a generally consistent thickness around the wheel rim 12.

In another approach according to an aspect of the present disclosure, the tape member 24 may be in the form of multiple pieces that are joined together via multiple butt joints 25 to define a complete circumferential tape coverage or nearly complete coverage.

The tape member 24 may be provided on a carrier or tape backing that is highly compliant or conformal, such that the tape member 24 will conform to the surface curvature of the bead flanges 20, 22 to which the tape member 24 is applied. The tape member 24, as it is being laid up on the bead flanges 20, 22, is secured to the bead flange 20, 22 via the application of pressure on the tape member 24 against the bead flanges 20, 22.

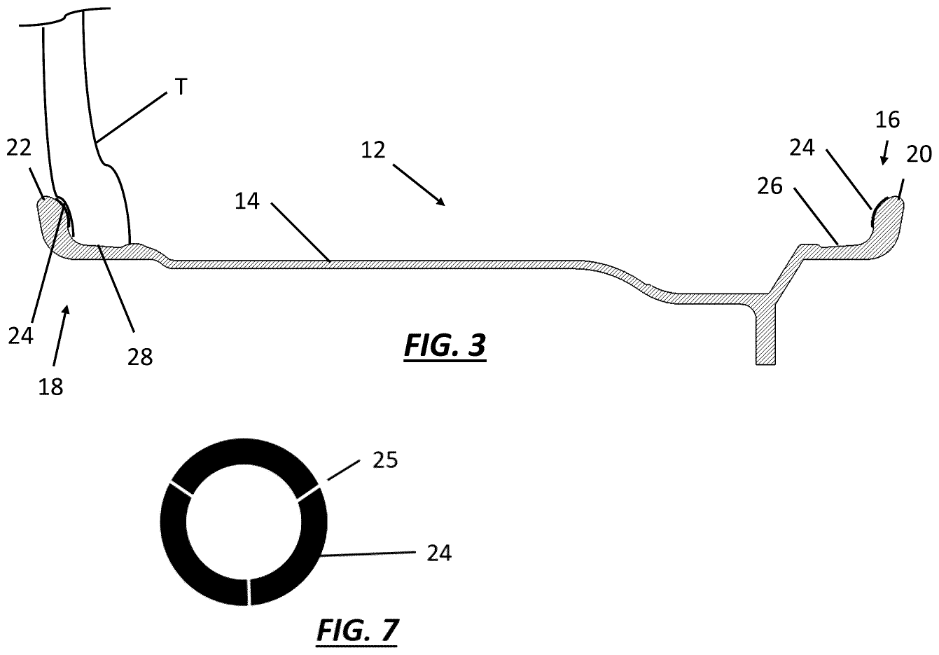

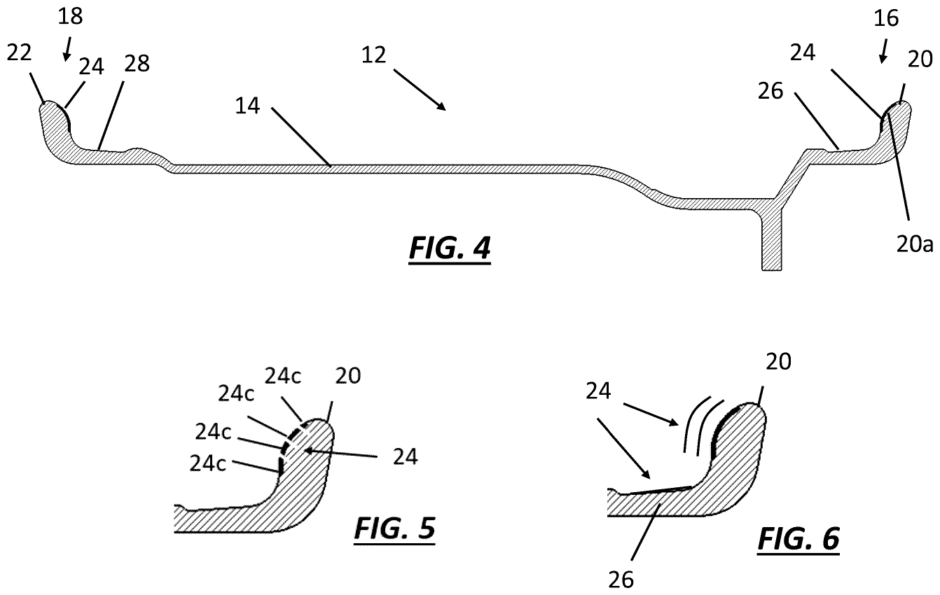

The tape member 24 being conformal to the bead flanges 20, 22, and its positioning on the bead flanges 20, 22 is illustrated more clearly in FIGS. 3 and 4. FIGS. 3 and 4 each illustrate an upper portion of a cross-sectional view of the wheel rim 12. It will be appreciated that a lower portion of the wheel rim 12 is effectively a mirror image of the view shown in FIGS. 3 and 4, and that FIGS. 3 and 4 represent the wheel rim 12 at various circumferential locations around the wheel rim 12.

FIG. 3 illustrates a first embodiment of the position of the tape member 24 relative to the bead flanges 20, 22. In FIG. 3, the tape member 24 is generally proud relative to the inner facing surfaces of the flanges 20, 22. Put another way, the tape member 24 is non-flush in this embodiment. The tape member 24, being applied to the curved surface of the bead flanges 20, 22, thereby projects relative to the surface of the bead flanges and presents a contact area provided by the tape member 24 against which the tire material will contact. A mounting section of a tire T is illustrated schematically in FIG. 3 in contact with the end 18. It will be appreciated that the tire T will also contact the end 16 in a similar fashion.

In FIG. 3, the front end 16 is shown on the right side of the figure, and the rear end 18 is shown on the left side of the figure. A front bead seat 26 is shown axially inward relative to the front bead flange 20 (to the left of bead flange 20 in the figure). A rear bead seat 28 is shown axially inward relative to the rear bead flange 22 (to the right of bead flange 22 in the figure).

As shown in FIG. 3, the bead seats 26, 28 are generally free from a high friction coating or other anti-slip structure in the form of projections or grooves. Accordingly the sealing between the tire to be mounted and the bead seats 26, 28 can be maintained without the interposition of such “non-smooth” structures. The bead seats 26, 28 here may be considered relatively smooth when compared to the high-friction properties provided by the tape member 24 on the bead flanges 20, 22.

The tape member 24 shown in FIG. 3, in one aspect, may be representative of a single strip of tape 24 that conforms to the surface of the flanges 20, 22 and wraps around the circumferential extent of the wheel rim 12, and forms a closed loop with a butt-joint (see FIG. 2) at the interface between opposing ends 24a, 24b of the tape 24.

It will be appreciated however, that FIG. 3 may also be representative of the tape member 24 being wrapped around the circumference of the wheel rim 12 multiple times, such that a plurality of layers of tape 24 are wrapped over each other, with additional layers increasing the overall thickness of the total amount of the tape 24 that projects from the surface of the flanges 20, 22. Thus, the illustration of FIG. 3 may be representative of one layer of tape or multiple stacked layers of tape. An illustration of multiple layers of tape 24 (shown exploded) is shown in FIG. 6, and is applicable in each case where multiple layers are referenced in the present disclosure.

Similarly, FIG. 3 may be representative of a plurality of single layer tape members 24 applied to different circumferential sections of the wheel rim 12, with multiple butt-joints, to create a generally continuous closed loop of the tape 24. One example of multiple sections to define the tape member 24 is shown in FIG. 7. Similarly, multiple circumferential sections may be layered upon each other, in a staggered manner, such that the butt-joints of the different layers of tape are at different circumferential locations.

In yet another aspect, FIG. 3 may be representative of a section of the tape member 24, where the tape member 24 is applied in distinct circumferential locations, with the sections of the tape member 24 being spaced apart from each other circumferentially, such that there is no butt-joint between adjacent sections of the tape 24. In this approach, some circumferential sections along the bead flanges 20, 22 may be without tape, for instance being bare.

In another aspect, some circumferential sections of the bead flanges 20, 22 may have more layers of tape relative to other sections.

The tape member 24 is shown as having the same general thickness and width at each of the flanges 20, 22. However, it may be desirable for the width and/or thickness of the tape member 24 at one of the flanges 20, 22 to be different than the tape member 24 at the opposite flange 20, 22. For example, the tape member 24 applied to the flange 20 may be wider and thicker than the tape member 24 at the other flange 22. Other relative sizes are also possible. In one aspect, one of the flanges 20 or 22 may have more layers of tape than the other to define different thicknesses of tape.

Turning now to FIG. 4, another embodiment of the wheel rim 12 with the tape member 24 applied. In this embodiment, the flanges 20, 22 of the wheel rim include a recessed cavity 20a, 22a, which is recessed into the inwardly facing surfaces of the flanges 20, 22.

The recessed cavities 20a, 22a have an annular and/or circumferential shape, and extend around the circumference of the wheel rim 12, thereby providing a path around the wheel rim 12 for the tape member 24 to be inserted. The cavity 20a, 22a may have a curved bottom surface, corresponding to the curved surface of the flange 20, 22, such that the cavity 20a, 22a has a generally consistent depth across its width.

The cavities 20a, 22a are shown as having approximately the same depths. However, the cavity 20a may have a depth that differs from the depth of cavity 22a. Similarly, the cavities 20a, 22a may have widths that differ.

The size of the cavity 20a, 22a, including both depth and width, may be selected based on the width and thickness of the tape member 24 to be applied at each of the corresponding flanges to achieve a generally flush application of the tape member 24 with the corresponding flange 20, 22.

However it will be appreciated that the cavities 20a, 22a may also be provided along with the tape member 24 such that the tape member 24 projects outwardly from the surface of the flange 20, 22 (thereby being proud relative to the bead flange surface, similar to the arrangement shown in FIG. 3). In this aspect, the tape member 24 is thicker than the depth of the corresponding cavity 20a, 22a.

In one aspect, the cavities 20a, 22a may have a generally flat bottom surface, such that the depth varies across the width of the cavity, and provides a flat surface for the tape member 24 to be applied.

Similar to the FIG. 3, FIG. 4 may be representative of a variety of arrangements of the tape member 24, including single layers, multiple layers, single circumferential sections, multiple circumferential sections, continuous circumferential coverage, and/or spaced apart sections.

In yet another aspect, FIG. 5 illustrates an arrangement of the tape member 24, where the tape member 24 includes multiple strips or rings 24c of the tape member 24 that are arranged next to each other up and down the inner surface of the flange 20, 22. Put another way, each of these rings 24c may be concentric, with the rings at the top of the bead flanges 20, 22 being of a greater diameter than those nearer the base of the bead flanges 20, 22. These separate rings 24c may be arranged spaced apart from each other along the surface of the flange 20, 22, or they may be arranged adjacent each other and in abutting contact with each other to define the overall contact area of the tape member 24.

The use of multiple tape rings 24c may be desirable in instances where the curvature of the flange 20, 22 is relative high, such that multiple strips 24c may conform more easily to the flange surface than a single width of the tape member 24. FIG. 5 illustrates the strips 24c disposed within a flange cavity, similar to FIG. 4 so as to create a generally flush arrangement relative to the bead flange surface, but it will be appreciated that the rings can also be provided on the wheel rim 12 of FIG. 3, with the strips projecting from the flange surface.

In yet another aspect, the tape member 24 may be applied to the bead seat 26, 28. In this approach, the bead seat 26, 28 may include a recessed cavity, similar to the cavities 20a, 22a. In this aspect, the tape member 24 will preferably have a thickness and width conforming to the shape of the cavity, such that the bead seat surface is generally flush. Accordingly, the tire to be mounted may still have a generally flush surface for the tire to contact, thereby providing sealing integrity between the tire and the bead seat even with the introduction of the high-friction tape member 24. The illustration of the tape member 24 according to FIG. 4, illustrating a flush arrangement, is accordingly applicable to this aspect. FIG. 6 illustrates one example of the tape member 24 applied to the bead seat 26, for example (along with multiple layers applied to the bead flange20). It will be appreciated that such an illustration is applicable to the other bead seat 28, and also applicable to single layer and multiple layer arrangements both separate and in combination with the tape member arrangements applied to the bead flanges. Thus, because the tape member 24 may also be applied to the bead seat 26, 28, and because the tire and wheel rim 12 meet at both the bead seats 26, 28 and the flanges 20, 22, the interface at which the wheel rim 12 and the tire meet where the tape member 24 may be applied can be referred to generally as a wheel-tire interface portion.

In another aspect, the tape member 24 may be applied to the bead seat 26, 28, but without also being applied to the flanges 20, 22.

The tape member 24 described above for use in the various above-described embodiments may be provided in a variety of constructions. In one aspect, the tape member 24 is in the form of a flexible film with an abrasive, high friction surface on its face, the face being arranged to be in contact with the tire when the tire is mounted. The opposite side of the tape member 24 may include an adhesive backing. The adhesive backing may be pressure activated after the tape is applied to the corresponding surface of the wheel rim 12. In another aspect, the tape 24 may be free from an adhesive backing, and the adhesive may instead be applied directly to the surface of the wheel rim 12 where the tape is to be installed.

The tape member 24, in the form of a film, is conformal, drape-able, and elastic, such that it may properly fit onto the annular shape of the wheel rim 12. The film of the tape member 24 may be made various material types, including paper, plastic, mesh, or bi-axially oriented fabric.

The abrasive particles provided in the tape may be up to 1 mm in diameter and may be made from any hard material including minerals such as silica, carbide, alumina, etc. In another aspect, the abrasive particles may be made from a hard plastic such as nylon. The size distribution of the particles may be multi-modal or mono-modal.

The abrasive particles may be encapsulated onto the film backing. The material that encapsulates the particles is preferably capable of adhering the particles to the film backing substrate, such that the particles will remain in place during high torque conditions of the mounted tire.

The above-described embodiments provide various examples of the multiple aspects of the present disclosure. The various features of the embodiments described above may be combined with other embodiments when not in conflict. It will be appreciated that the above described example embodiments are but some examples, and that the scope of coverage of the present disclosure is not limited to the above-described embodiments.

What is claimed is:

1. A vehicle wheel structure comprising:
a wheel rim having a rotational axis, a front end and a rear end at opposite axial ends of the wheel rim, and a body portion extending between the front end and the rear end,
a front flange disposed at the front end and a rear flange disposed at the rear end, wherein the front and rear flanges project radially outward from the body portion;
a front bead seat of the front end disposed axially inward relative to the front flange;
a rear bead seat of the rear end disposed axially inward relative to the rear flange;
a wheel-tire interface portion disposed at both the front end and the read end of the wheel rim; and
an anti-slip tape applied to the wheel-tire interface portion, wherein the anti-slip tape includes a high-friction surface facing outwardly from the wheel rim such that a tire mounted to the wheel rim is in direct contact with the high-friction surface of the tape member.

2. The vehicle wheel structure of claim 1, wherein the wheel-tire interface portion at which the tape is applied is disposed on an axially inner surface of the front flange and the rear flange.

3. The vehicle wheel structure of claim 1, wherein the wheel-tire interface portion at which the tape is applied is disposed on the front bead seat and the rear bead seat.

4. The vehicle wheel structure of claim 1, wherein the tape is disposed in a recess formed in the wheel rim such that the wheel rim and the tape combine to define a flush surface.

5. The vehicle wheel structure of claim 1, wherein the tape includes an adhesive disposed between the tape and the wheel-tire interface portion of the wheel.

6. The vehicle wheel structure of claim 5, wherein the adhesive is provided on a backing of the tape.

7. The vehicle wheel structure of claim 5, wherein the adhesive is provided on the wheel rim at the wheel-tire interface portion.

8. The vehicle wheel structure of claim 1, wherein the tape includes a plurality of abrasive particles configured to engage a contact surface of the tire.

9. The vehicle wheel structure of claim 8, wherein the particles have a mono-modal size distribution or a multi-modal size distribution.

10. The vehicle wheel structure of claim 1, wherein the tape extends in a substantially continuous loop circumferentially around the wheel rim.

11. The vehicle wheel structure of claim 10, wherein the tape extends around the wheel rim multiple times and defines multiple layers.

12. The vehicle wheel structure of claim 1, wherein the tape is compliant and conforms to a surface curvature of the wheel-tire interface portion.

13. A vehicle wheel structure comprising:
a wheel rim having a rotational axis, a front end and a rear end at opposite axial ends of the wheel rim, and a body portion extending between the front end and the read end,
a front flange disposed at the front end and a rear flange disposed at the rear end, wherein the front and rear flanges project radially outward from the body portion;
a wheel-tire interface portion disposed at both the front end and the read end of the wheel rim on the front and rear flange; and
an anti-slip tape applied to the front flange and the rear flange on an axially inner surface thereof, wherein the anti-slip tape includes a high-friction surface facing outwardly from the wheel rim such that a tire mounted to the wheel rim is in direct contact with the high-friction surface of the tape member.

14. The vehicle wheel structure of claim 1, wherein the tape projects from the axially inner surface and is proud relative to the axially inner surface.

15. The vehicle wheel structure of claim 13, wherein the tape is provided within a recess or cavity formed in the axially inner surface, and the tape is flush with the axially inner surface of the front and/or rear flanges.

16. The vehicle wheel structure of claim 13, wherein the tape includes multiple separate sections disposed around the circumference of the wheel along the front and rear flanges.

17. The vehicle wheel structure of claim 13, wherein the tape includes a plurality of separate concentric rings that are disposed adjacent each other on the front and/or rear flange.

18. The vehicle wheel structure of claim 13, wherein the wheel rim is a composite rim or an alloy rim.

19. The vehicle wheel structure of claim 13, further comprising a tire mounted to the wheel rim and sealed with a front bead seat and a rear bead seat of the wheel rim, wherein the tape is in direct contact with the tire and the wheel rim at the front flange and the rear flange, wherein the abrasive surface of the tape is in direct contact with the tire, and an adhesive is disposed between the tape and the wheel rim.

20. The vehicle wheel structure of claim 19, wherein the tape is disposed between the tire and the front flange and between the tire and the rear flange.
